(19) United States
(12) Patent Application Publication
(10) Pub. No.: US 2021/0012129 A1
(43) Pub. Date: Jan. 14, 2021

(54) Method of registering and identifying a user of a voice-controlled device

(71) Applicant: Himanshu Kaul, Cedar Park, TX (US)

(72) Inventor: Himanshu Kaul, Cedar Park, TX (US)

(21) Appl. No.: 16/508,320

(22) Filed: Jul. 11, 2019

(51) Int. Cl. G06K 9/00; G10L 17/22

(52) U.S. Cl. CPC G06K 9/00926; G10L 17/22; G06K 9/00281; G06K 9/00288; G06K 9/00315; G06K 9/00335; G06K 9/0061; G06K 9/00362

(57) ABSTRACT

The present invention is related to a method of registering and identifying a user of a voice-controlled device. The method comprising: registering the user of the device, determining at least one of a facial, eye and body features of the user upon determining at least one characteristic of a voice input from the user is below a threshold level, determining an output upon comparing the determined at least one of the facial, eye and body features of the user with a prestored information associated with the user in a database and identifying the user in accordance with the determined output.

### FIELD OF THE INVENTION

The present invention is related to a method of registering a user of a voice-controlled device, and more particularly, to the method of registering and identifying the user of the voice-controlled device.

### BACKGROUND OF THE INVENTION

User authentication has become popular nowadays as internet and network-based computer usage have become more prevalent and capabilities of these have grown. The significance of user authentication has also increased as businesses, government departments, medical organizations, and individuals have become increasingly reliant on computer networks and on the security of proprietary information transmitted across networks to users of computing devices.

Today many voice-controlled devices assist users with general tasks such as finding weather information, calling a friend, setting clock and reminders, playing music and many more. Voice-controlled devices may offer access to some information to multiple users of a workplace or household. However, other information provided by the voice-controlled device may be private to specific individuals. Therefore, user authentication is compulsory.

### SUMMARY OF THE INVENTION

In accordance with one embodiment, a method of registering a user with a voice-controlled device is provided. The method comprising: receiving at least one voice input from the user in response to at least one query, determining at least one voice characteristics of the user, determining at least one of a facial, eye and body features of the user, storing an information in a database upon association the determined voice characteristics with at least one of the facial, eye and body features of the user and updating the information in the database upon determining at least one change in the at least one facial, eye and body features of the user.

In accordance with another embodiment a method of identifying a user by a voice-controlled device is provided. The method comprising: determining at least one of a facial, eye and body features of the user upon determining at least one characteristic of a voice input from the user is below a threshold level, determining an output upon comparing the determined at least one of the facial, eye and body features of the user with a prestored information associated with the user in a database and identifying the user in accordance with the determined output.

In accordance with another embodiment a method of identifying a user by a voice-controlled device is provided wherein the method comprising: determining at least one characteristic of a facial feature of the user upon determining at least one characteristic of a voice input from the user is below a threshold level, determining at least one characteristic of a body feature of the user, upon determining the at least one characteristic of a facial feature of the user is below a threshold level, determining an output upon comparing the determined at least one characteristic of the body feature of the user with a prestored information associated with the user in a database and identifying the user in accordance with the determined output.

One exemplary embodiment provides a method configured to recognize the voice inputs of many users who are having different voice characteristics and enabling at least one user to perform operation via voice-controlled device.

According to one aspect of the invention the method of registration of a user with a voice-controlled device comprising registering one or more users in association with one voice-controlled device wherein the registered user is enabled to perform one or more operations using the device.

According to another aspect of the present invention, during registration of a user with the device the user is associated with one or more privilege wherein the one or more privilege may permit the newly registered user to initiate one or more operations performed by the device that are not permitted prior to registration. The device may be one of the but not limited to a voice-controlled device, a voice assistant, a biometric device.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the flow chart of the method of registering a user with a voice-controlled device in accordance with preferred embodiment of the present invention.

FIG. 2 illustrates the flow chart of the method of identifying a user by a voice-controlled device in accordance with the preferred embodiment of the present invention.

FIG. 3 is a flow chart illustrating the method of the present invention.

### DETAILED DESCRIPTION OF THE INVENTION

The present methods will be more completely understood through the following detailed description which should be read in conjunction with the attached drawing in which similar reference numbers indicate similar structures. All references cited above and in the following description are hereby expressly incorporated by reference.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation.

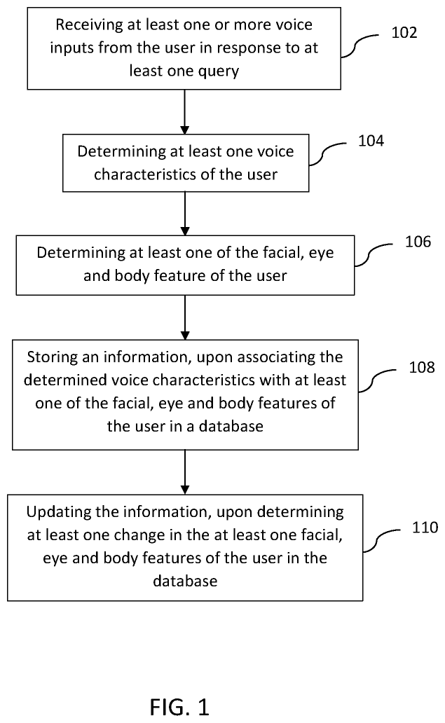

FIG. 1 illustrates the flow chart of the method of registering a user with a voice-controlled device in accordance with preferred embodiment of the present invention. The method comprises: At Step (102), receiving at least one or more voice inputs from the user in response to at least one query wherein the at least one or more voice inputs are captured via one or more microphones of the device. The at least one query is generated via the device at the time of registering a new user. At Step (104), determining at least one voice characteristics of the user wherein the voice characteristics are voice prints of the user. The voice prints include, but are not limited to, the frequency of the voice, as well as attributes such as dynamics, pitch, duration, intonation and loudness of the voice. At step (106), determining at least one of the facial, eye and body feature of the user via a camera of the device wherein the camera is configured to capture one or more features of the user. At Step (108), storing an information, upon associating the determined voice characteristics with at least one of the facial, eye and body features of the user in a database. At step (110), updating the information, upon determining at least one change in the at least one facial, eye and body features of the user in the database.

In one example, if the user profile is already existing in the database and if the user-stored facial or body feature is changed or may be significantly different from that of the facial or body feature captured via the camera at the time of registering. For example, the two facial images may depict the same user but are captured at different periods of the time and his/her facial features have changed. The method is configured to update the at least one change in the at least one facial, eye and body features of the user in the user-stored profile.

According to one exemplary embodiment, the facial feature may include eyebrows, cheeks, chin, ears, hairs, eyes, head dimensions, facial gestures such as wink, smile, nod and other expressions or combination of facial components such as distance between eyeballs, shape of nose, distance from eyes to mouth. The camera of the device is configured for scanning the facial patterns of the user for recognition and identification of the user via their facial features. The captures facial feature and voice input of user are used to create the profile of the user.

In some embodiments the method includes determining the facial feature of the user via extracting the facial recognition data from one or more captured image of the user. The extracted facial recognition data is stored in the cloud based database. Further the method includes obtaining one or more words or phrases spoken by the user via one or more microphones. These obtained one or more words or phrases spoken by the user is used to extract voice characteristics of the user.

According to another exemplary embodiment the eye feature may include one of the but not limited to iris feature, scleral feature that can be used for eye tracking. Eye features can be referred as individual key points. Such eye features may be unique to an individual's eye and may be distinct for each eye of that individual. The iris feature can be point of particular color density as compared to the rest of the iris color or a pattern of the iris can be identified as an iris feature. In some cases, the term eye feature may be used to refer to any type of identifying feature in or on the eye whether the feature is in the iris, the sclera or feature seen through the pupil (for example, on the retina).

According to another exemplary embodiment of the present invention, the body feature may include one of the face, texture of skin, hairstyle or a limb (e.g. an arm and/or a leg), brand name of the clothing worn by the user (for example user has worn shirts of brands like Nike, Tommy Hilfiger and glasses of brands like Ray-Ban, adidas, Gucci). The clothing may include shirts, pants and/or other clothing such as dress, coat, hat, gloves, shoes and accessories like glasses, jewelry and likewise.

According to another exemplary embodiment of the present invention the voice-controlled device is configured to recognize user using face and body features. In order to update the body features on everyday basis, the device uses face recognition as authentication for registering body features i.e. every day in the morning the device will look for faces, track those faces and corresponding bodies of the users to update body features. Once the body features are updated, then device is enabled to recognize the user from far distance using those features.

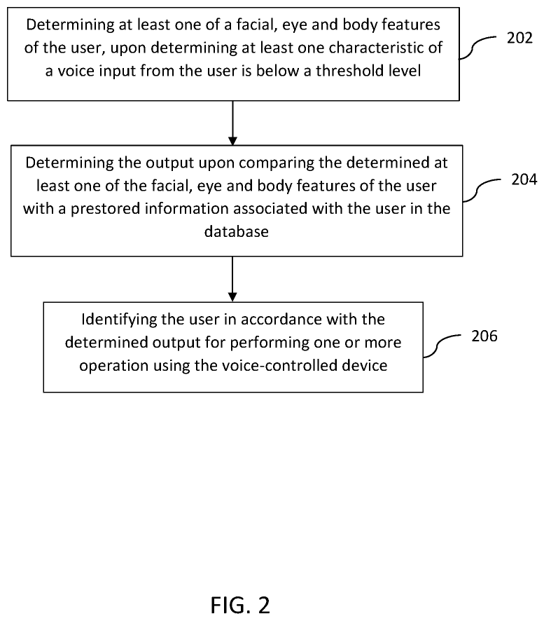

FIG. 2 illustrates the flow chart of the method of identifying a user by a voice-controlled device in accordance with the preferred embodiment of the present invention. The method comprises: At Step (202), determining at least one of a facial, eye and body features of the user, upon determining at least one characteristic of a voice input from the user is below a threshold level. At Step (204), determining the output upon comparing the determined at least one of the facial, eye and body features of the user with a prestored information associated with the user in the database. At Step (206), identifying the user in accordance with the determined output for performing one or more operation using the voice-controlled device. Further, the at least one of a facial, eye and body features of the user is determined by the camera of the device wherein the camera is a 360 degree rotatable camera.

According to one aspect of the invention, the method is configured for determining if the at least one characteristic of the voice input of the user is below the threshold level i.e. voice recognition score is below a threshold value. This happens when the user voice changes due to sore throats and coughs or user is not audible. Further, the method is configured for determining the voice characteristics of the utterance word or phrase with an existing stored voice print of the user and based on the comparison value above a threshold level the user is either accepted or else rejected.

In an embodiment the method is configured for comparing at least one of the facial, eye and body features of the user with the prestored user information in the database. For example, the method selects facial features include dimensions based on facial landmarks. For example, the distance between a user's eyes, the triangular shape between the eyes and nose and width of the mouth can be used as a facial feature of the user and then compare the user's facial feature with the database of prestored information from user's profile.

In one example the method is configured for determining multiple facial images of the user and analyzing the facial images for indication of liveness wherein liveness can be indicated by facial gestures such as movement of the eye, mouth and other portions of the face.

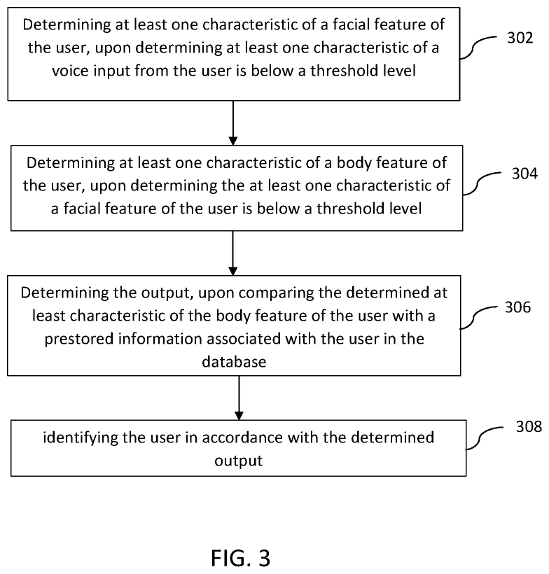

FIG. 3 is a flow chart illustrating the method of identifying the user of the device wherein the method comprising: At Step (302), determining at least one characteristic of a facial feature of the user, upon determining at least one characteristic of a voice input from the user is below a threshold level. At Step (304), determining at least one characteristic of a body feature of the user, upon determining the at least one characteristic of a facial feature of the user is below a threshold level. At Step (306), determining the output, upon comparing the determined at least characteristic of the body feature of the user with a prestored information associated with the user in the database. At Step (308), identifying the user in accordance with the determined output.

According to one exemplary embodiment of the present invention, the method is configured for determining at least one characteristic of a body feature of the user, upon determining the at least one characteristic of a facial feature of the user is below a threshold level (i.e. user face is not visible). The method determines at least one characteristic of a body feature of the user such as body shape, height, hairstyle, user clothing etc. The extracted body feature is compared against stored body features of the user in the database for identifying or rejecting the user.

According to one exemplary embodiment of the present invention the method of identifying the user by a voice-controlled device can be used for identifying the users in a restricted areas, identifying persons in homes and offices etc.

It will be apparent from this list that although specific embodiments of the present invention are illustrated and described in this specification, modifications of those embodiments may be made without departing from the present invention concept.

1. A method of identifying a user by a voice-controlled device comprising:
determining at least one of a facial, eyes and body features of the user, upon determining at least one characteristic of a voice input from the user is below a threshold level;
determining an output, upon comparing the determined at least one of the facial, eyes and body features of the user with a prestored information associated with the user, in a database; and
identifying the user in accordance with the determined output.

2. The method of claim 1, wherein the threshold level is, at least partially, a non-audible voice input.

3. The method of claim 1, wherein the facial feature is at least one of eyebrows, cheeks, chin, ears, hairs, eyes, head dimensions, facial gestures such as wink, smile, nod and other expressions or combination of facial components such as distance between eyeballs, shape of nose, distance from eyes to mouth. The camera of the device is configured for scanning the facial patterns of the user for recognition and identification of the user via their facial features. The captures facial feature and voice input of user are used to create the profile of the user.

4. The method of claim 1, wherein the eye feature is at least one of an iris, the sclera or feature seen through the pupil.

5. The method of claim 1, wherein the body feature is at least one of texture of skin, hairstyle, and apparels.

6. A method of identifying a user by a voice-controlled device comprising:
determining at least one characteristic of a facial feature of the user, upon determining at least one characteristic of a voice input from the user is below a threshold level;
determining at least one characteristic of a body feature of the user, upon determining the at least one characteristic of a facial feature of the user is below a threshold level;
determining an output, upon comparing the determined at least characteristic of the body feature of the user with a prestored information associated with the user, in a database;
identifying the user in accordance with the determined output.

7. The method of claim 6, wherein the threshold level is, at least partially, a non-audible voice input.

8. The method of claim 6, wherein the facial feature is at least one of eyebrows, cheeks, chin, ears, hairs, eyes, head dimensions, facial gestures such as wink, smile, nod and other expressions or combination of facial components such as distance between eyeballs, shape of nose, distance from eyes to mouth. The camera of the device is configured for scanning the facial patterns of the user for recognition and identification of the user via their facial features. The captures facial feature and voice input of user are used to create the profile of the user.

9. The method of claim 6, wherein the eye feature is at least one of an iris, the sclera or feature seen through the pupil.

10. The method of claim 6, wherein the body feature is at least one of texture of skin, hairstyle, and apparels.
